(19) United States
(12) Patent Application Publication
(10) Pub. No.: US 2023/0371443 A1
(43) Pub. Date: Nov. 23, 2023

(54) MODULAR SYSTEMS FOR TRANSPORTATION OF PLANTS AND METHODS OF USE THEREOF

(71) Applicant: SYNGENTA CROP PROTECTION AG, Basel (CH)

(72) Inventors: Johannes Everardus Eek, Delft (NL); Thomas Jan Hessling, Delft (NL); Josef Maria Fischer, Kleve (DE); Lennart Holm Johnsen, De Lier (NL)

(73) Assignee: SYNGENTA CROP PROTECTION AG, Basel (CH)

(21) Appl. No.: 18/030,309

(22) PCT Filed: Oct. 4, 2021
(86) PCT No.: PCT/US2021/053353

§ 371 Date: Apr. 5, 2023

Related U.S. Application Data
(60) Provisional application No. 63/089,643, filed on Oct. 9, 2020.

(51) Int. Cl. A01G 9/02; B65D 85/50; A01G 9/029

(52) U.S. Cl. CPC A01G 9/023; A01G 9/028; B65D 85/50; A01G 9/0299

(57) ABSTRACT

Systems are described for plant propagation and transportation. The systems include modular stackable carriers and modular stackable trays, wherein the trays accommodate plant pots, and wherein the carrier accommodate the trays. Trays and carriers may be stacked and nested in various configurations to create ensembles based on a desired functions, such as for transportation, storage or stowage.

### RELATED APPLICATIONS

This application claims priority from U.S. Provisional Application No. 63/089,643, filed Oct. 9, 2020, the disclosures of which are incorporated by reference herein in their entirety.

### TECHNICAL FIELD

The present invention relates to modular plant transportation systems, including stackable trays and stackable carriers that can be paired in different configurations, and methods of using such systems for transporting living plant material.

### BACKGROUND

Plant agriculture can generally be divided into three broad categories: (a) agronomy (i.e., herbaceous field crops grown on a large scale in cultivated fields); (b) forestry (i.e., forest trees and related products); and (c) horticulture (i.e., edible garden crops and plants for ornamental use). As with many other industries throughout the world, plant agriculture has evolved into a high specialized, commercial enterprise advanced by science and technology so as to efficiently and cost effectively deliver products in pace with the ever-increasing demand of these products.

Arguably, in the past few decades, the fastest growing segment of plant agriculture as a whole is in the area of ornamental plants. Increased desire in using plants for interior decorating, emphasis on home and garden decoration and designing neighborhood and community land with aesthetically pleasing plants have all contributed to the demand for ornamental plants. This increased demand has generated a multi-billion dollar industry integrally supported by horticulturalists, botanists, geneticists, nurserymen, landscape architects, arborists, garden center operators, pest control specialists, and professional landscape services to name a few.

The increased demand for ornamental plants has fueled innovation in the horticultural industry for the mass propagation of elite, high yielding and disease free plants. Among such advancements is the method of young plant production. Mass production of young plants generally involves professional breeders and propagating companies that develop plant starting material, which it then ships or delivers to professional growers. The plant starting material is typically in the form of cuttings (rooted or unrooted), seedlings, or tissue-cultured propagules. Once delivered to the growers and/or plant raisers, the plant starting material is placed into propagation trays or liners where they are grown side by side in small cells in a propagation media that has been specifically developed to reduce weeds or diseases and provide a suitable environment to accommodate the plant at this fragile state of its life.

The trays or liners are then placed within a controlled environment, such as a greenhouse where the young plant begins to grow. State of the art greenhouses are equipped with computer-controlled system capable of monitoring the progress and quality of thousands of plant trays. Once the plant trays are ready to leave the green houses, they are transported to a professional grower who then removes the plant from its initial cell in the tray and into a larger container or field with the appropriate growing medium to sustain the growing plant.

When the young plant is ready to leave the greenhouse, it is still quite fragile and its transportation to the wholesalers who then distribute the product to the retailers. Alternatively, some retailers will import the young plants directly from the growers. Regardless of the selected links in this chain, it may be easily appreciated that some degree of care must be exercised in transporting these plants at such a vulnerable stage of their life while balancing the need to cost effectively transport these plants in mass quantities.

A common practice of transporting the trays is for the trays to leave the grower in movable carriers, or so-called “Danish trolleys”. The trolleys are then rolled from place to place until the young plants reach their destination. On these trolleys, the trays are set upon an exposed shelving unit that generally lends itself to the displacement of the trays and subjects the young plants to damage or even loss. Further, the load capacity of these trolleys is very inefficient. Another common practice is to place the trays inside corrugated packaging solutions. However, the young plants need to be well ventilated and the boxes disrupt the view of the young plants for quality checks. Further, cardboard boxes generate waste and thus are not cost effective and take up humidity/water resulting in softer material and thus unstable for stacking one on top of another.

With reference to FIG. 1 through FIG. 3, three types of propagation trays 10, 20, and 30 are shown. These propagation trays 10, 20, and 30 are known in the art. Each tray contains cells 11, 21, and 31, which are adapted to receive plant starting material (not shown). Once disposed therein, the plant starting material is provided with a suitable environment to permit growth of the material into young plants 22, 32, shown for example in FIGS. 2 and 4. In commercial operations, the filled trays are placed in greenhouses where the plants can be grown in a controlled environment.

Once the young plants are mature enough, they are ready to be transplanted either in a field or another suitable container with the proper growth media to support the next stage of the plant's life. In commercial operations, for example, the filled propagation trays 36 are collected and loaded onto wheeled trolleys 40 such as the one shown in FIG. 5. The trolleys are then transported to professional growers.

As shown in FIG. 5, exemplary trolley 40 contains a vertical array of shelves 42 and filled trays 36 simply disposed thereon. Shelves 42 do not contain any sidewalls to offer protection for plants 32 during such a vulnerable stage in its life cycle.

However, such plant transportation systems have many issues. As one example, such systems tend to be expensive. As another example, such systems may not provide adequate protection to vulnerable plants during transportation. Particularly, plants may be exposed on the sides. There may also not be sufficient height available above the tray, leaving the tips of the young plants prone to damage. Further, when not in use, such systems can require significant storage space. Accordingly, there is a need for solutions to reduce or eliminate loss or injury of young plants and provide added security measures to protect the young plants while they are transported to their destination. There is also a need to provide a carrier and carrier system that enables the young plants to remain visible during transportation and delivery for quality control purposes. At the same time, it is also desirable to meet these needs without frustrating the carrier's ability to deliver mass quantities of young plants in a manner that is both time efficient and economically feasible. Finally, there is a need to be able to provide trolleys and shelves than be easily stored.

### SUMMARY

The present invention continues the effort to develop new systems for transporting living plant materials. Accordingly, the present invention is directed to plant transportation systems comprising stackable carriers and stackable trays. The stackable carriers and stackable trays can be arranged in multiple different configurations based on functional requirements. Each tray of the system is adapted to receive multiple pieces of plant propagation material while each carrier of the system is capable of accommodating a tray thereon. By stacking multiple carriers and placing trays on each carrier of the stack, a palletized configuration is achieved which simplifies plant transport from a sender location. Then, once the young plants have been received and transferred out at a recipient location, individual carriers can be stacked to create a carrier ensemble while individual trays can be stacked to create a tray ensemble. This allows for easy storage, transportation, and reuse of the carriers and trays. The design of the stackable carriers is adapted to reduce plant damage during transportation.

In one exemplary embodiment, a carrier system comprises a carrier and a tray that is accommodated on the carrier. The carrier comprises a perforated base, a pair of opposing side walls extending upwards from the base to a first height, a pair of opposing end walls extending upwards from the base to a second, different height, a plurality of spaced apart first connector elements extending upward from each side wall, a plurality of spaced apart second connector elements extending downwards from each side wall, wherein each of the plurality of first connector element is sized and adapted to engage with the second connector element of a similarly constructed carrier, an upper surface of the base comprising one or more raised sliding rails for torsional stiffness. The tray is accommodated on the upper surface of the base of the carrier, the tray comprising a rectangular frame enclosing a plurality of open-ended cells arranged in an array, each cell enclosing a central cavity for receiving a plant pot, a bottom surface of each cell comprising one or more spacer elements, wherein the tray is insertable onto and/or removable from the base of the carrier via sliding interaction between at least some of the spacer elements over at least some of the sliding rails. The tray is insertable and/or removable onto/from the base via the sliding interaction while the first connector element of the carrier is engaged to the second connector element of a similarly shaped carrier stacked on top of the given carrier.

In some embodiment, walls of each cell have a first, lower region that extends straight upwards from a bottom surface of the cell, and a second, upper region which flares outwards. Further, the tray has a frame comprising opposing end walls and opposing side walls, and wherein the opposing end walls of the tray are beveled outwards away from the array of cells of the tray.

A lower surface of the base of each carrier further comprises diagonal ribs, raised outwardly away from the bottom surface, the diagonal ribs configured to provide torsional stiffness to the carrier. The diagonal ribs may be arranged at an angle to each other to form a cross brace on the lower surface of the base. The first height of the side walls of the carrier may be greater than the second height of the end walls of the carrier.

In one embodiment, the tray is accommodated onto the carrier over an end wall of the carrier, and wherein upon accommodating the tray on the carrier, lateral movement of the tray is limited via the side walls of the carrier and longitudinal movement of the tray is limited via the terminal walls of the carrier.

In one embodiment, the one or more sliding rails of the carrier include a central sliding rail raised from the base of the frame and extending along a central longitudinal axis of the carrier. In further embodiment, the one or more sliding rails includes one or more peripheral sliding rails, parallel to and offset from the central sliding rail.

In one exemplary embodiment, the carrier further comprises a nesting element comprising an opening at a corner of the base, and wherein when another similarly constructed carrier is nested on top of the given carrier, the second connector element of the another carrier is received through the opening of the given carrier. In one embodiment, the another carrier is offset from the given carrier when nested on top of the given carrier, and the another carrier is not offset from the given carrier when stacked on top of the given carrier via engagement of the second connector element of the another carrier with the first connector element of the given carrier. A distance between a beveled end wall of the tray and the array of cells continuously increases from a top surface of the end wall to a bottom surface of the end wall. A cavity is provided between the beveled end wall of the tray and a terminal row of cells in the array, and the cavity is sized to accommodate a lifting means therein.

In some embodiments, opposing end walls of the carrier have a double-walled configuration including an inner end wall layer coupled to an outer end wall layer via slanted ribs, wherein the inner end wall layer is shorter than the outer side wall layer along at least some of the length of the end wall. At a central portion of the end wall, the inner end wall layer and the outer end wall layer have a common height. In some further embodiments, the perforated base comprises perforations extending from the top surface to the bottom surface of the base, and distributed uniformly over an entirety of the base. In different embodiments, the perforations include perforations of varying size, and may comprise a leaf shaped perforation.

The present invention is further directed to a layered carrier system, or carrier ensemble, having a plurality of plant transportation carriers that can be stacked on top of each other. Each carrier comprises a base having an upper surface and a lower surface and a plurality of perforations extending through the base; a pair of opposing side walls extending upwards from the base to a first height; a pair of opposing end walls extending upwards from the base to a second, different height; a plurality of spaced apart first feet extending upwards from each side wall; a plurality of spaced apart second feet extending downwards from each side wall, the first feet aligned with corresponding second feet, the first feet comprising a groove for accommodating the first feet of another carrier layered on top of the given carrier; one or more sliding rails raised away from the upper surface of the base; one or more ribs raised away from the lower surface of the base; and an opening at each corner of the base. In some embodiments, the plurality of spaced apart first feet and second feet extend from the base along each side wall at a location proximate to a junction of the side wall with a corresponding end wall. In an exemplary embodiment, a height of the first feet is different from the height of the second feet, particularly, a height of the first feet is greater than the height of the second feet. A plant growing tray can be inserted or removed from the base of the carrier via sliding interaction of the tray with the sliding rail of the carrier, and wherein once the tray is accommodated on the base, lateral and longitudinal motion of the tray is limited via the end and side walls of the carrier, respectively.

Based on the availability of space, carriers may be stacked on top of each other to create an ensemble of stackable carriers with all edges aligned, or with edges offset from one another. In one exemplary embodiment, an ensemble of stackable carriers comprises at least a first carrier and a second carrier as described above, wherein when the second carrier is layered on top of the first carrier, the second feet of the second carrier are matingly engaged with the groove of the first feet of the first carrier such that the first carrier and second carrier are axially aligned. In some embodiments, the ensemble further comprises a third carrier as described above wherein when the third carrier is layered on top of the first carrier, the second feet of the third carrier are accommodated within the groove of the first carrier such that the third carrier is axially offset from each of the first and the second carrier.

The present invention also describes a method of creating an ensemble of stackable carriers, wherein each carrier of the ensemble is configured as described above. In one exemplary embodiment, the method comprises placing, on a first carrier as described above, a similarly configured second carrier; and engaging the second feet of the second carrier in a mated relationship with the groove of the first carrier such that the first carrier and second carrier are axially aligned. In some embodiments, the method further comprises placing a third similarly configured carrier on the first carrier; and nesting the second feet of the third carrier through the opening of the base of the first carrier such that the third carrier is axially offset from the first carrier. In some embodiments, the third carrier is nested with the first carrier below the second carrier, and wherein the third carrier is axially offset from the second carrier.

The present invention also describes a plant propagation tray for placement on the carrier. The present invention is further directed to a layered tray system, or tray ensemble, having a plurality of plant growth trays that can be stacked on top of each other. In one exemplary embodiment, each tray comprises a plurality of open ended cells arranged in an array, the array enclosed within a rectangular frame, each cell defining a cavity for receiving a plant pot; a plurality of spaced structural ribs running along a length and a width of a bottom surface of the array, thereby creating a lattice support structure below the array; and a set of beveled spacer elements extending, at an angle, from a bottom rim of each cell towards a central axis of the cell. The lattice structure includes a central aperture coaxial with the cavity of each cell, and wherein the beveled spacer elements do not extend over the central aperture. An upper rim of each cell flares away from the central axis of the cell, and engages with the upper rim of an adjacent cell at a raised post. In some embodiments, the raised post has a central opening for accommodating an identification element including an identification flag. Each cell is substantially quadrangular in shape, and in some embodiments, an inner surface of each cell is recessed at each corner and protrudes inwards in a region between adjacent corners. Each cell is coupled to an adjacent cell at the upper rim, and adjacent cells are separated from each other at a lower rim. The rectangular frame has a pair of opposing end walls and a pair of opposing side walls, and wherein each end wall of the rectangular frame is beveled, slanting outwards from a top edge to a bottom edge of the end wall. In some embodiments, an outer surface of each end wall of the rectangular frame comprises a tabbed slot for accommodating an identification element. The end walls of the rectangular frame are narrower at a central region relative to end regions proximate a side wall. The narrower central region has a notched upper surface, and wherein when a similarly configured tray is layered on top of a given tray, the end wall of the another tray is accommodated in the notched upper surface of the given tray, thereby engaging the given tray to the another tray.

Like the carriers, the trays may be stacked such that tray edges are aligned or offset from each other. In some embodiments, the spacer elements of a cell of a given tray are accommodated within the cavity of an underlying cell of another similarly configured tray when the given tray is stacked on top of the another tray. In such an arrangement, the trays are axially aligned when stacked. In some embodiments, the spacer elements of a cell of a given tray are accommodated on a raised post of an underlying cell of another similarly configured tray when the given tray is nested on top of the another tray. In such an arrangement, the trays are axially aligned with the end wall of the given tray offset from the end wall of the another tray when stacked.

The present invention also describes a method of creating an ensemble of stackable trays, wherein each carrier of the ensemble is configured as described above. In one exemplary embodiment, the method comprises placing, on a first tray as described above, a similarly configured second tray; and engaging the spacer elements of each cell of the array of the second tray in the cavity of corresponding cells of the array of the underlying first tray such that the first tray and second tray are axially aligned. In another exemplary embodiment, the method comprises, placing, on a first tray as described above, a similarly configured second tray; and engaging the spacer elements of each cell of the array of the second tray with the raised post of corresponding cells of the array of the underlying first tray such that the first tray and second tray are axially offset. Herein, the first tray and second tray are axially offset includes the end walls of the first tray and second tray being axially offset from each other while side walls of the first tray and second tray are axially aligned.

The present invention is also directed to a system of stackable carriers and stackable trays in various combinations with each other and in combination with one or more living plant materials. The combination of stackable carriers and trays can be further combined with one or more pallets.

The present invention is also directed to methods of transporting one or more items, such as living plant materials, between a sender location and a recipient location. In one exemplary embodiment, the method of transporting one or more items comprises a method of transporting one or more living plants to an intended recipient by placing individual plants within individual cells of a stackable tray as described herein, and then accommodating the tray within a stackable carrier as described herein. Multiple carrier-tray units can be stacked to create a palletized configuration.

Finally, the present invention is also directed to methods of transporting the carriers and trays, as described herein. In one exemplary embodiment, a plurality of the carriers described herein can be transported by placing a second carrier on top of a first carrier such that first feet of the second carrier are accommodated within a groove of second feet of the first carrier resulting in a configuration where the first carrier and second carrier are axially aligned. The method allows for further layering of a third, similarly constructed carrier on the second carrier such that when the third carrier is layered on top of the second carrier, the first feet of the third carrier are accommodated within the opening of the second carrier resulting in a configuration where the third carrier is axially offset from each of the first and the second carrier. The stacked are then placed on a pallet for transportation or for storage. In another exemplary embodiment, a plurality of the trays described herein can be transported by placing a first tray on top of a second tray, such that the terminal wall of the second tray is accommodated in the notched upper surface of the first tray, thereby engaging the first tray to the second tray. In such a setting, the spacer elements of a cell of a first tray are accommodated within the cavity of an underlying cell of a second tray when the first tray is stacked on top of the second tray, resulting in a configuration where the trays are axially aligned upon stacking. In another exemplary embodiment, the spacer elements of a cell of a first tray are accommodated on a raised post of an underlying second tray when the first tray is nested on top of the second tray, such that the trays are axially aligned with the terminal end of the first tray offset from the terminal end of the second tray when nested. The stacked trays are then accommodated in a pallet for further transportation or storage.

These and other features and advantages of the present invention will become apparent after a review of the following detailed description of the disclosed embodiments and the appended claims.

### BRIEF DESCRIPTION OF THE DRAWINGS

The present invention is further described with reference to the appended figures showing exemplary embodiments of the present invention, wherein:

FIG. 1 is a perspective view of a plant propagation tray as known in the art;

FIG. 2 is a perspective view of a plant propagation tray, also as known in the art, containing young plants therein;

FIG. 3 is a perspective view of yet another propagation tray as known in the art;

FIG. 4 is a perspective view of a filled propagation tray shown in FIG. 3 and showing an example of a young live plant disposed in one of the cells thereof;

FIG. 5 is a perspective view of a plurality of filled propagation trays disposed on a trolley for transportation;

FIG. 6 is a perspective view of a plant transportation system comprising a carrier and a plant propagation tray according to the present invention;

FIG. 7 is a perspective view of the carrier;

FIG. 8 is a top view of the carrier;

FIG. 9A shows a cross sectional view through the end wall of the carrier along an offset longitudinal axis B-B;

FIG. 9A shows a cross sectional view through the end wall of the carrier along a central longitudinal axis A-A;

FIG. 10A is a side view of the carrier when looking at a side wall;

FIG. 10B is a side view of the carrier when looking at an end wall;

FIG. 11 is perspective view of a bottom surface of the carrier;

FIG. 12 is a perspective view of an example embodiment of a stacked ensemble of carriers including carriers aligned with one another and carriers offset from one another;

FIG. 13 is a top isometric view of the stacked ensemble of carriers;

FIG. 14 is a side isometric view of the stacked ensemble of carriers;

FIG. 15 is a top perspective view of a plant propagation tray that can be accommodated on a carrier of the present invention;

FIG. 16 is a side perspective view of the plant propagation tray;

FIG. 17 a side view of the plant propagation tray viewed along a terminal end of the tray;

FIG. 18 is a side view of the plant propagation tray viewed along an edge of the tray;

FIG. 19 is a top view of the plant propagation tray;

FIG. 20 is a partially exploded top view of a cell of the tray;

FIG. 21 is a cross-sectional view of a cell of the tray;

FIG. 22 is a partially exploded perspective view of a cell of the tray;

FIG. 23 is a side view, taken along a tray end, of a first example embodiment of a stacked ensemble of trays comprising trays aligned with one another;

FIG. 24 is a side view, taken along a tray edge, of the first example embodiment of a stacked ensemble of trays;

FIG. 25 is a side cross-sectional view, taken along the edge, of the first example embodiment of a stacked ensemble of trays comprising trays aligned with one another;

FIG. 26 is a partially exploded cross-sectional view of the first example embodiment of a stacked ensemble showing the relative positioning of channels of a first tray interlocked with channels of a second tray;

FIG. 27 is a perspective view of the first example embodiment of a stacked ensemble of trays comprising trays offset from one another;

FIG. 28 is a side view, taken along a tray end, of a second example embodiment of a stacked ensemble of trays comprising trays offset from one another;

FIG. 29 is a side view, taken along a tray edge, of the second example embodiment of a stacked ensemble of trays;

FIG. 30 is a side cross-sectional view, taken along the edge, of the second example embodiment of a stacked ensemble of trays comprising trays offset from one another;

FIG. 31 is a partially exploded cross-sectional view of the second example embodiment of a stacked ensemble showing the relative positioning of channels of a first tray interlocked with channels of a second tray;

FIG. 32 is a perspective view of the second example embodiment of a stacked ensemble of trays comprising trays offset from one another;

FIG. 33 is a perspective view of a plant transportation system showing the accommodation of a plant propagation tray onto a carrier to form a tray-carrier unit, and the stacking of multiple such units;

FIG. 34 is a side view of a plant transportation system showing the accommodation of a plant propagation tray onto a carrier to form a tray-carrier unit;

FIG. 35 is a high level flowchart depicting an example method of operating a modular plant transportation system comprising stackable carriers and trays to facilitate plant propagation while also providing compact storage capabilities.

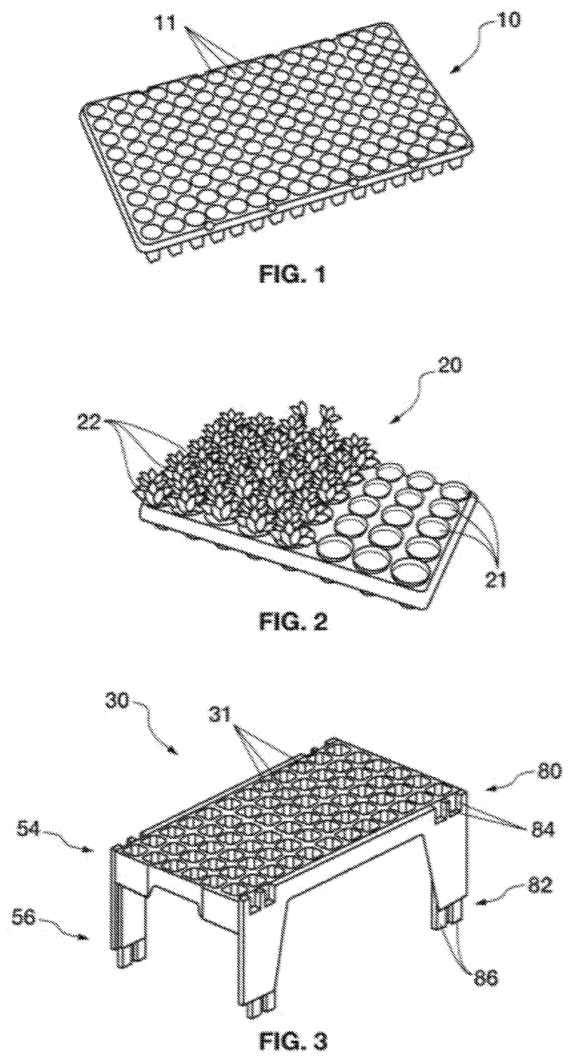

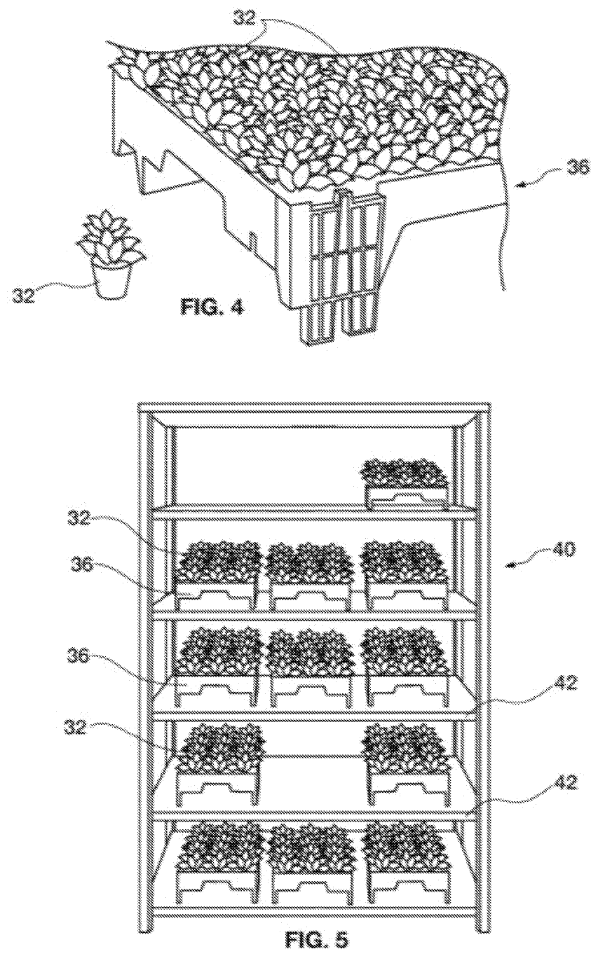

### DETAILED DESCRIPTION

According to the present invention, a modular plan transportation system is provided comprising one or more carriers and more or more plant propagation trays, wherein the carriers and trays are stackable in various combinations. Each carrier is configured to accommodate a tray on its surface. Each tray is configured to accommodate multiple young plants (e.g., potted plants). Placement of the tray on the carrier results in the creation of a single carrier system unit, also referred to herein as a tray-carrier unit. Multiple such units can be stacked via coupling of the carriers to provide a palletized system for transporting large quantities of young plants in a compact and protected manner.

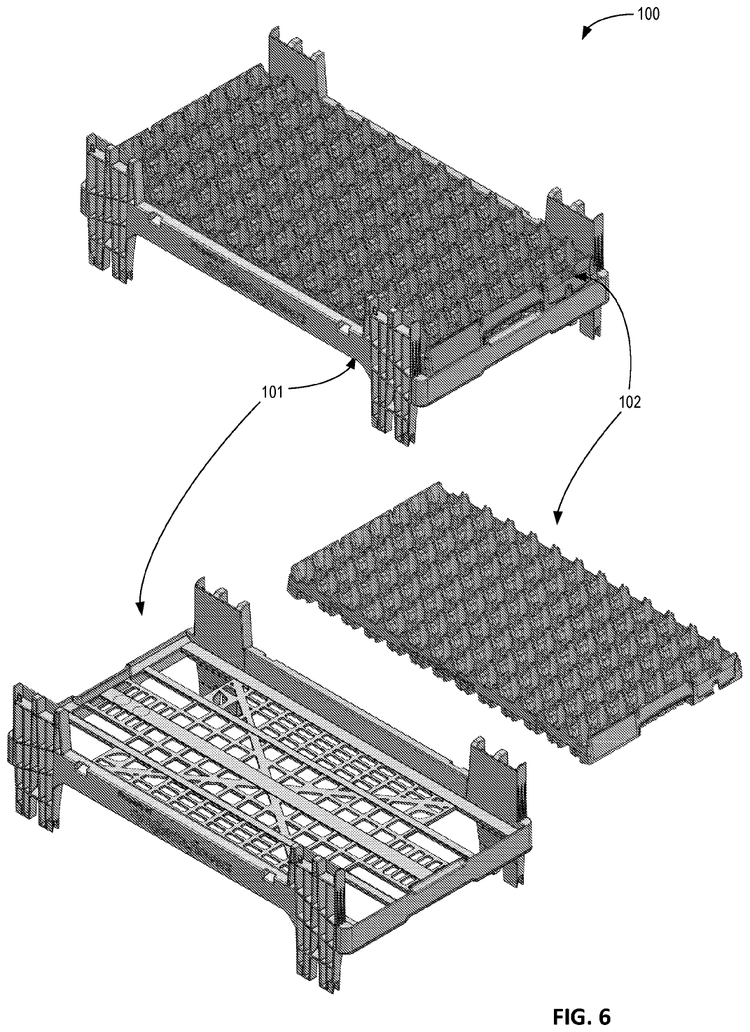

With reference now to FIG. 6, a plant transportation system 100 is shown in accordance with the present invention. Plant transportation system 100 is configured for transportation of plant material. In one example, the system enables transportation of multiple self-contained plant growth medium pots having growth substrate enveloped in a covering and a plant propagation unit embedded within the medium. The plant propagation unit may be any plant material that allows for production of a fully mature plant. As non-limiting examples, the plant transportation system may be used for the shipment of young plants, seeds, and seedlings. The components of the plant transportation system may be sized to accommodate plants of any size and shape. System 100 comprises at least one carrier 101 and at least one plant propagation tray 102. As described below, young plants are housed within channels of the tray, with the tray arranged on the carrier, and multiple such carrier-tray units stacked together, to create a protected environment that reduces risk of injury to the young plants during shipment. As further described below, the system may include multiple carriers and multiple trays. Further, the system may include multiple carriers stacked to create a carrier ensemble and/or multiple trays stacked to create a tray ensemble.

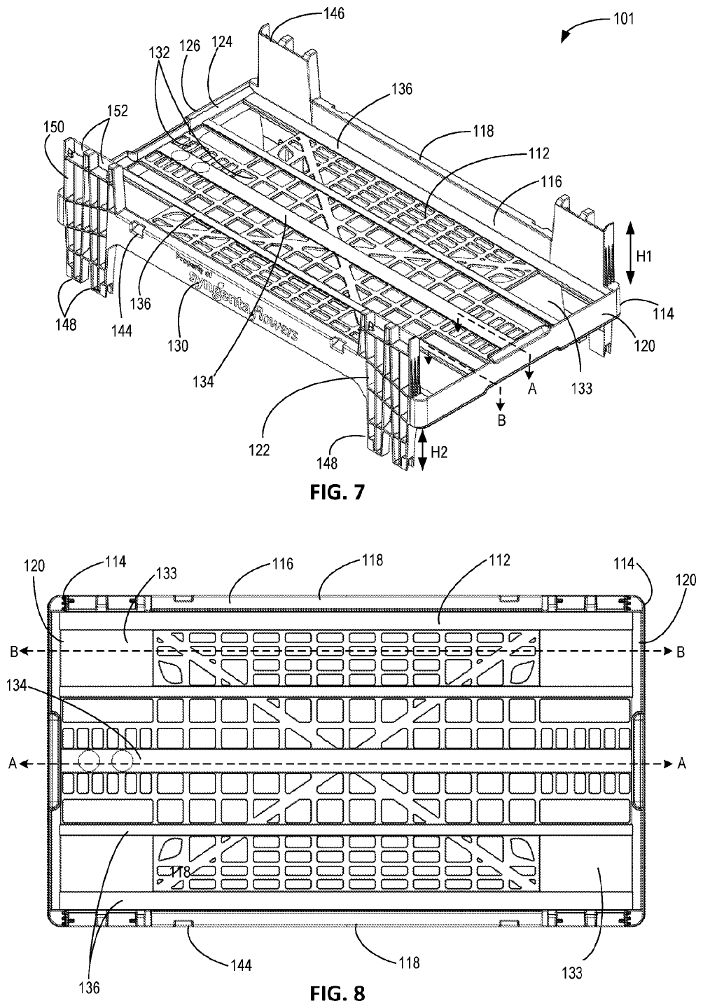

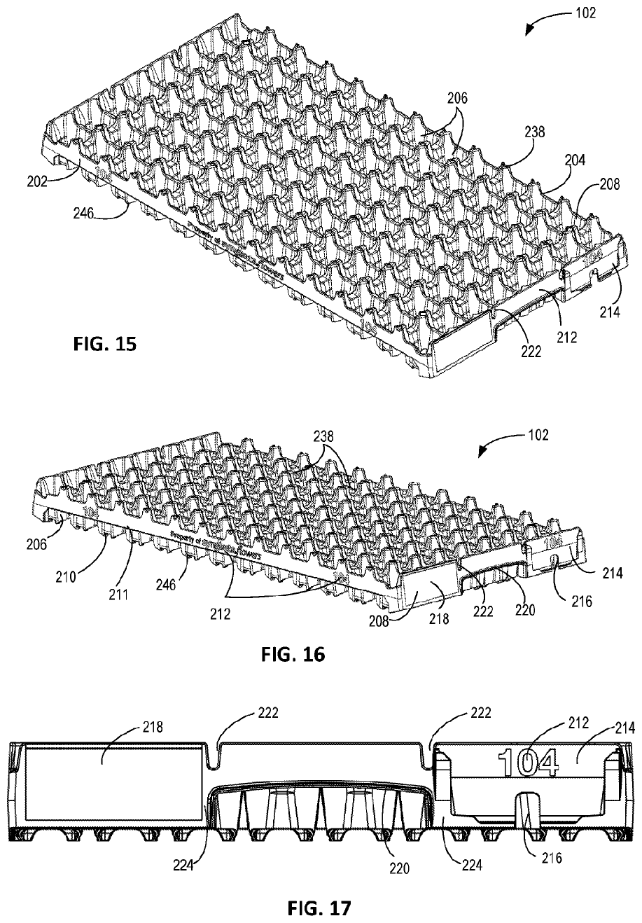

A detailed embodiment of carrier 101 is shown at FIGS. 7-11. A detailed embodiment of plant propagation tray 102 is shown at FIGS. 15-22. Geometric axes (xyz) are provided for orientation reference.

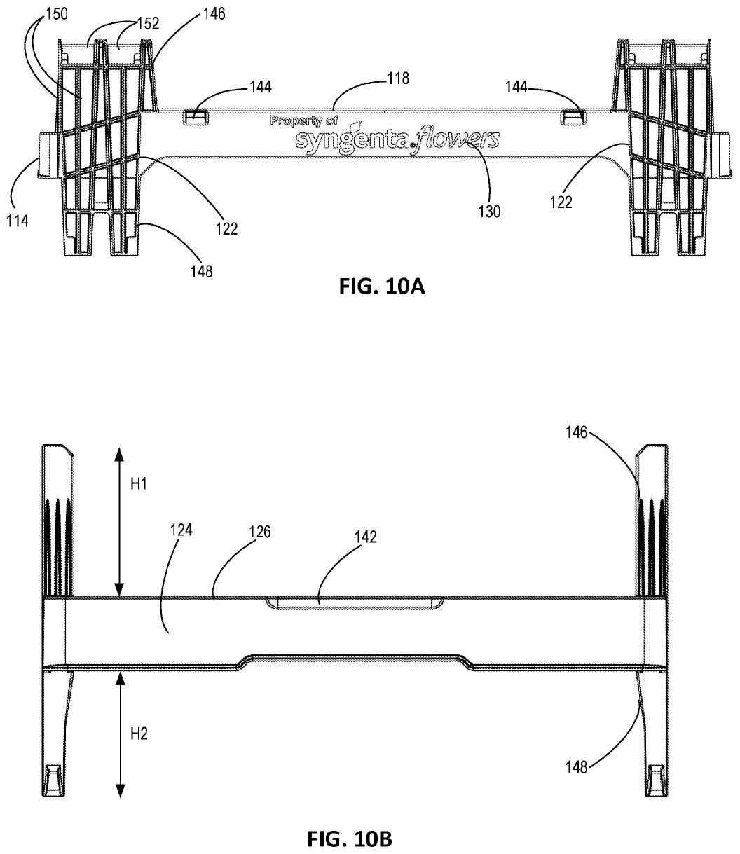

Turning first to carrier 101, with reference to FIGS. 7-11, it has a rectangular geometry. Carrier 101 comprises a substantially rectangle-shaped base 112 with rounded corners 114. In the depicted embodiments, the base is a perforated base surrounded by a solid frame 116 which defines the edges and ends of the carrier. However in other embodiments, the base may be a solid base with no perforations. When received, a plant propagation tray is accommodated on the base and a volume of growing space available for plants on the tray is defined by the contours of the frame. The frame comprises a pair of opposing side walls 118 that extend upwards from the base to a first height and a pair of opposing end walls 120 that extend upwards from the base to a second, different height. The pair of opposing side walls are arranged parallel to one another, and likewise the pair of opposing end walls are arranged parallel to one another. The side walls 118 are longer than end walls 120. In the depicted example, as particularly illustrated at FIG. 10A, the pair of opposing side walls 120 extend to a higher height than the height of the end walls 120. In one non-limiting example embodiment, the frame has a length of 535 mm, a width of 300 mm and a height of 164.5 mm. Further, in the example embodiment, the side walls have a height of 38.5 mm while the end walls have a height of 35.4 mm.

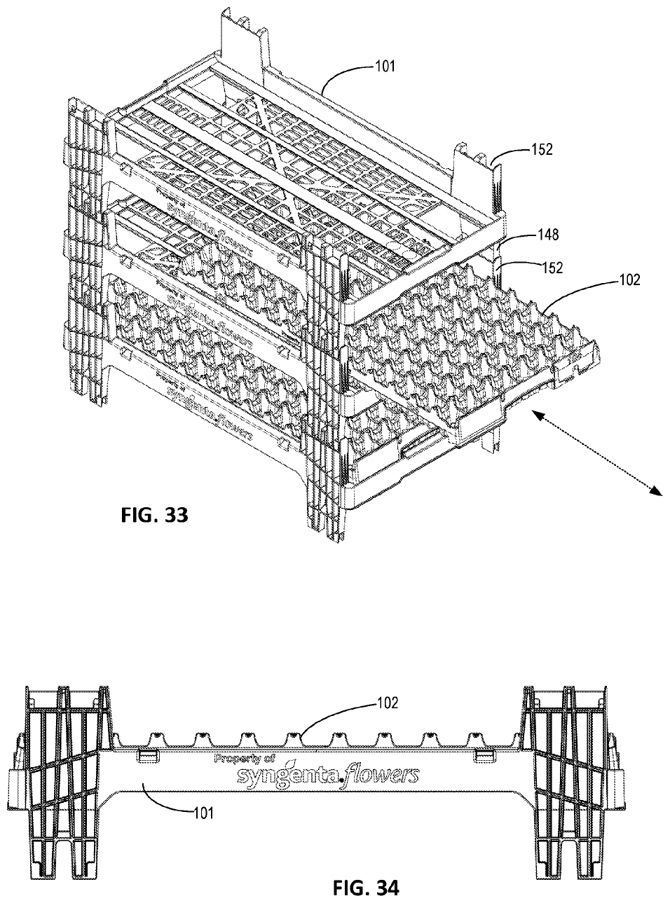

A plant propagation tray 102 is received on or removed from the carrier 101 along a terminal end of the carrier (FIG. 33) by sliding the tray over the upper surface of the base and over an end wall 120. The frame of the carrier, comprising the side walls and end walls, protects the plants on the tray received on the carrier. The shorter height of the end walls facilitates the sliding placement and removal of the plant propagation tray on the base 112. Upon accommodating the tray on the carrier, lateral movement of the accommodated tray is limited via the greater height of the side walls of the carrier while further longitudinal movement of the tray is limited via the end walls of the carrier. The shorter height of the end walls also allows identification indicia provided on the tray, such as barcodes, labels, flags, or other printed matter, to be easily visible to a user. Specifically, the differential height of the carrier walls allows a user to identify the contents of a tray placed on the carrier without the need to explicitly remove the tray. In this way, a user may be able to rapidly identify the plants within a stack of carrier-tray units, such as in a palletized configuration.

In one exemplary embodiment, identification indicia are provided on the shorter end walls of the tray and on the shorter end walls of the carrier. In such an embodiment, a user may be able to easily see both identification indicia when the tray is positioned on the carrier.

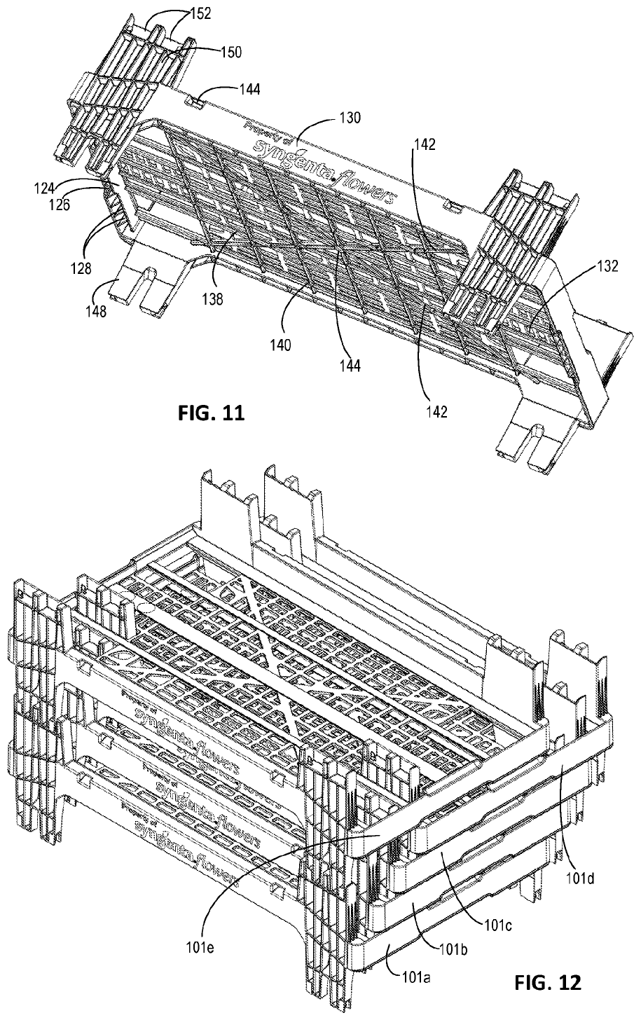

Each side wall 118 is arranged perpendicular to each end wall 120. At each end of each side wall 118, an angled frame structure 122 is provided that gradually rises from the height of the end wall to the height of the side wall, as best illustrated at FIG. 10A. The presence of the angled structure enables the height of the frame to seamlessly transition from the first height of the side wall to the second height of the end wall. As a result of the inclusion of the angled frame structures, as best shown at FIGS. 10A and 11, the lower edge of the side wall is at a different height or plane relative to the lower edge of the end wall. Particularly, a top surface of the base is at a higher plane along the side walls and at a lower plane along the end walls.

The end walls and side walls of the frame are integrally molded with the base and may be made of plastic. Indicia 130 may be provided on the outer surface of the frame, along the side walls. The indicia may be printed, pasted, embossed, etc., and may include indicia of any selected type, such as decorative indicia, trademarks, identification indicia, product information, operating instructions, and the like.

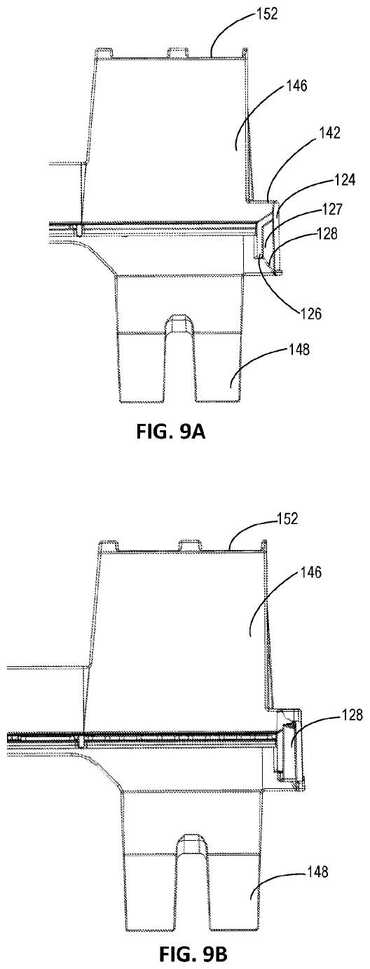

End walls 120 have a double walled structure with a shorter inner end wall layer 124 separated from a longer outer end wall layer 126 by a gap 127, and wherein the inner wall layer is coupled to the outer wall layer via slanted ribs 128 extending through gap 127, as best illustrated at the sectional views of FIGS. 9A-B. The inner wall layer 124 is chamfered inwards (from the wall towards the interior of the carrier) to provide additional space for plants stored on the carrier. In one example, the inner wall layer inclines inwards by a 45 degree angle. Such an arrangement provides various advantages. First, it provides further structural reinforcement, while also maximizes the growing space available for young plants placed on a tray on the carrier. In addition, the slanted structure extending from the shorter inner wall to the longer outer wall acts as an end stop that secures a tray placed on the carrier. As a result, longitudinal movement of the tray can be limited and the tray can be held in place without the need for an explicit locking element (such as a snap-on feature). Further, trays can be placed or removed from a carrier even when carriers are stacked (such as when multiple carrier-tray units are stacked one above another).

A width of the carrier frame is uniform along the side walls 118 (see FIG. 10A, for example). In comparison, as best shown at FIGS. 7 and 10B, a width of the carrier frame varies along the end walls 120 due to the incorporation of a central groove 142 where the outer wall layer curves inwards and abuts the inner wall layer with no intervening gap. The end wall is narrower at the central groove 142 relative to regions of the end wall extending beyond the groove. The central groove results in an ergonomically advantageous finger pocket. Particularly, the groove allows a user to access a tray placed on the carrier without needing to go under the tray, and without dislocating any young plants on the tray. The groove allows the carrier to be handled both manually by a user as well as robotically when using automation (e.g., when a robotic arm is used for pallet handling). One or more recesses 144 may also be provided on side wall 118 to accommodate handling equipment. These may include, as non-limiting examples, automated tray handling or plant handling equipment, automated washing equipment, in field automated processing equipment (for placing the carrier with or without trays on the ground or for lifting them from the ground); automated palletizing equipment, and automated grading equipment.

The rectangular base 112 has an upper surface and a lower surface with perforations 132 extending through an entire depth of the base from the upper surface to the lower surface. The perforations enable optimal airflow through the bottom of the carrier onto the trays placed on the carrier. This improves airflow to the roots of each plant accommodated on the tray. In addition, the perforations allows for substantially constant environmental conditions (e.g., humidity) to be provided to each plant on the tray. Further, the perforations simplify access to, and handling of, a tray placed on the carrier. For example, a user may be able to lift the tray by accessing it from below the carrier via the perforations. Likewise, the user may be able to lift the carrier and/or a stack of carriers by accessing the bottom surface of the carrier via the perforations.

Perforations 132 may be distributed uniformly or non-uniformly over the area of the carrier base. The perforations may have any desired shape and may be arranged to provide any desired pattern. Further, a size and shape of the perforations may be uniform or may vary over the length and width of the base. For example, as shown at FIGS. 7-8, larger perforations are provided at a central portion of the base, the perforations reducing in size radially outwards from the central portion, with the smallest perforations provided at the edges of the base, along the walls. In the depicted example, the perforations are largely quadrangular in shape with at least some perforations having a visibly-distinguishing pattern, such as a trademark pattern (e.g., a leaf pattern in the depicted example). In some embodiments, the arrangement of the perforations is based on the position of structural elements (e.g., ribs) provided on a bottom surface of the base (detailed below) wherein the perforations are designed to correspond to regions between horizontal, vertical, and/or diagonally placed structural elements. It will be appreciated that in alternate embodiments, the base may be a solid base having no perforations.

In addition to the perforations, the base of the carrier 101 may include nesting elements 133 which are configured as openings at a corner of the base. In some embodiments, one nesting element is provided at each corner 114 of the base. As elaborated below, with reference to FIGS. 12-14, the nesting elements of a first carrier are adapted to engage with connector elements (described below) of one or more other carriers enabling multiple carriers to be stacked together to create a compact ensemble for easy storage and transportation, particularly when not in use with trays. Nesting elements may be designed and sized to match, or be a function of, the size and dimensions of connector elements (146, 148) of the carrier. In one example embodiment, each nesting element is sized to accommodate the connector elements from at least 3 other carriers stacked one upon each other in an ensemble.

One or more sliding rails 134, 136 are embossed on the upper surface of the carrier base and are provided to enable a plant propagation tray to be slidably inserted or removed from the carrier without getting stuck. The sliding rails are raised relative to the upper surface of the carrier. In one example embodiment, the sliding rails extend 0.5 mm above the upper surface of the carrier base. As elaborated at FIGS. 16, 17 and 21, spacer elements are included at a bottom of a tray 102 that enable a sliding interaction between a bottom surface of the tray over the sliding rail(s) of the carrier. The sliding rails can also add torsional stiffness to the structure of the carrier.

The one or more sliding rails 134, 136 having a rectangular structure and can extend substantially along an entire length of the carrier, from one end wall to an opposing end wall. More specifically, the sliding rails couple one inner end wall layer to an opposing inner end wall layer. The one or more sliding rails include at least a central sliding rail 134 running along on a central longitudinal axis A-A of the carrier. Additional peripheral sliding rails 136 are provided that are parallel to the central sliding rail, and offset from the central longitudinal axis, such as along offset longitudinal axis B-B. Still other peripheral sliding rails may run along an edge of the base, juxtaposed next to the side edge of the carrier frame. The peripheral sliding rails may be uniformly distributed over the base in relation to the central sliding rail. A number of peripheral sliding rails may be varied based on a size of the carrier, the number of peripheral rails increased as the size of the carrier (and the area of the base) increases. In some embodiments, the number and location of the sliding rails may be designed to match the location of spacer elements provided on plant propagation trays to be used with the carrier. In still further embodiments, only a central sliding rail is provided. While all the sliding rails have a common length, the width of the rails may be the same or may vary. In the depicted embodiment, the central sliding rail has a width that is greater than the width of the peripheral sliding rails offset from the central axis, and the same width as the peripheral sliding rails provided along the edge of the base. In other embodiments, the central sliding rail may be wider than all peripheral sliding rails.

A plurality of support structure elements are embossed on a bottom surface of the base. As illustrated at FIGS. 7, 8 and 11, the support structure elements may be configured as ribs that extend outwards from the bottom surface, and away from the carrier base. In one example, the ribs extend away from the bottom surface of the carrier base by 3 mm. These ribs provide rigidity and torsional stiffness to the overall structure of the carrier and improve resistance to deformation. The support structure elements can include any combination of vertically, horizontally, and diagonally oriented structure elements. In the depicted example, a first set of vertical ribs 138 run along a length of the carrier, parallel to the longitudinal axes (A-A and B-B) while a second set of horizontal ribs 140 run along a width of the carrier, perpendicular to the longitudinal axes, creating a lattice structure on the undersurface of the carrier. The ribs are shown uniformly spaced across the length and width of the carrier, although in other embodiments, they may be non-uniformly distributed. The structural elements further include one or more diagonal ribs 142 extending from one corner 114 of the carrier to a diagonally opposite corner. For example, a pair of diagonal ribs may be arranged at an angle to each other to create a cross bracing, X-shaped structure on the bottom surface of the carrier base. In one embodiment, the diagonal ribs are mutually perpendicular. The structural elements impart structural strength to the carrier. In one example embodiment, torsional stiffness is provided through the use of a single X-shaped structure made of a pair of diagonal ribs and without the need for additional horizontal and vertical ribs. In one example, embodiment the carrier may be referred to as an “X-carrier” due to the incorporation of the cross-bracing structure.

In one non-limiting embodiment, the diagonal ribs and at least a portion of the first set of the vertical ribs and second set of horizontal ribs may extend from a central point 144 on the bottom surface of the carrier. Herein, the structural elements form a “hub and spoke” configuration. The structural elements may be provided along a common plane, wherein each of the ribs extends beyond the bottom surface of the carrier to a common degree. In other embodiments, the structural elements may be provided at different planes. For example, the diagonal ribs may create a cross bracing X-shaped structure in a plane closer to the bottom surface of the carrier while the horizontal and vertical ribs may create the lattice structure over the diagonal ribs, causing the lattice structure to project outwards beyond the X-shaped structure. Alternatively, the horizontal and vertical ribs may create the lattice structure in a plane closer to the bottom surface of the carrier while the diagonal ribs create the X-shaped structure over the horizontal and vertical ribs, causing the X-shaped structure to project outwards beyond the lattice structure.

The combination of the perforated base and the cross bracing diagonal ribs allows the carrier to provide sufficient ventilation for growth of plants being transported thereon. The ample airflow reduces the likelihood of root circling at the bottom of the plants. The combination of the perforations with the cross bracing diagonal ribs results in the carrier being light yet sturdy.

Carrier 101 further comprises a plurality of spaced apart first connector elements 146 (herein also referred to as first feet) extending upward from each side wall 118 to a first height H1, and a plurality of spaced apart second connector elements 148 (herein also referred to as second feet) extending downwards from each side wall 118 to a second height H2. Pairs of first and second connector elements are provided along a vertical plane that is common to each other and to the side wall such that the pair of connector elements appear as projections extending from the side wall. As a result of this arrangement, each pair of connector elements can be molded as a single structure extending from the side wall to a top surface of the first connector element in a first direction and from the side wall to a bottom surface of the corresponding second connector element in a second, opposite direction. The plurality of spaced apart first feet and second feet extend from the base at least along an end of each side wall, at a location proximate to a junction of the side wall with a corresponding end wall. In other words, at least four first and four second connector elements may be provided extending from the side wall 118 near corresponding four corners 114 of the carrier.

A height H1 of the first feet is configured to be different from the height H2 of the second feet. In particular, the feet extending above the surface of the carrier extend to a greater height than the feet extending below the surface of the carrier. This allows for a larger clearance height between carriers when stacked. For example, the clearance height can be raised above industry standards which are conventionally used for transporting plants. Specifically, when stacked, a total height H1+H2 is provided between consecutive carriers. Further, a larger carrier volume is provided for accommodating plants. When a plant tray is accommodated on the carrier and a similar carrier is stacked above the given carrier for transportation of the plants (see FIG. 33 for example), the larger clearance height (sum of H1 and H2) ensures that damage to the plants is minimized, particularly to the youngest, most vulnerable shoot structures at the top of the plant.

An inner face of all the connector elements 146, 148, on the side directed towards the carrier, has a solid, and substantially smooth surface. In comparison, the outer surface of all the connector elements 146, 148, on the side directed away from the carrier, has a lattice structure comprising uniformly spaced vertical columns 150 running from a top of the first connector element to a bottom of a corresponding second connector element. The vertical columns 150 act as reinforcing structures that add strength and stiffness, allowing the carrier to bear the weight of a tray placed thereon, as well as the weight of any additional carriers stacked above it, without breaking, bending, or bowing. Optionally, uniformly spaced horizontal rows may be provided that mesh with the vertical columns and provide additional reinforcement to the lattice structure.

At the upper surface of the terminal end (the end that is further away from the side wall), the first connector element 146 comprises a groove 152 sized to accommodate and engage, in a mated relationship, with the second connector element 148 of another similarly constructed carrier stacked on top of the given carrier. When stacked, a second connector element 148 is nested inside the corresponding first connector element 146. This allows for multiple carrier-tray units to be stacked one on top of another to create a palletized configuration, as shown in FIGS. 33-34, that can be moved and transported with ease. In some embodiments, in addition to groove 152, a pallet holding feature (not shown) may be provided on the first connector element to enable a wooden pallet to be engaged to a carrier (such as a top-most carrier in a stack of carrier-tray units, or the top-most carrier of an ensemble of stacked carriers).

The first and second connector elements of the stackable carriers may also be matingly engaged to create an ensemble of carriers as shown in FIGS. 12-14. The carriers may be stacked with at least some carriers aligned with each other and at least some carriers offset from each other to create a palletized structure that has the dimensions matching a standard pallet. This allows multiple carriers to be stacked compactly for easy storage, stowage, and transportation, when not being used for transporting plant trays.

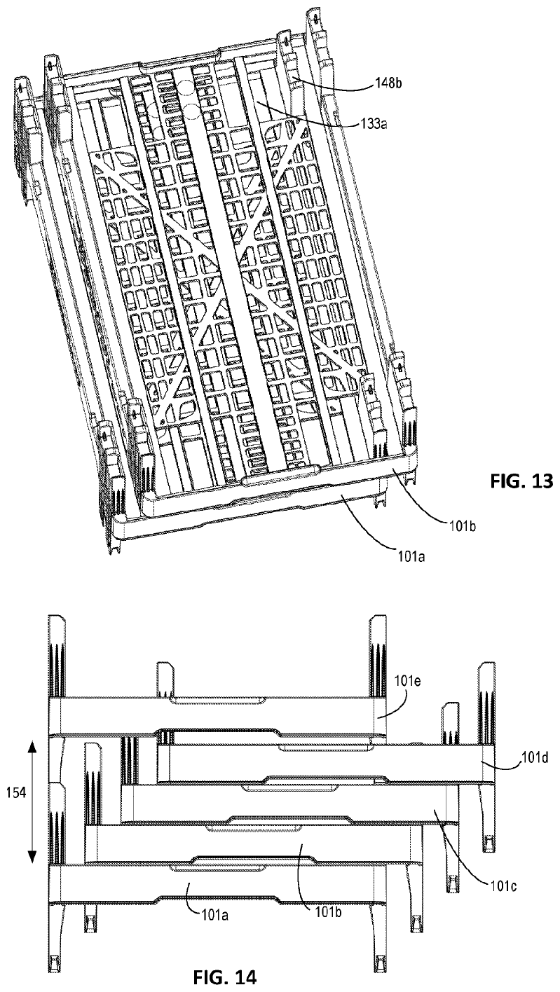

In one example embodiment, as depicted at FIGS. 12 and 14, multiple carriers may be stacked in a mutually offset arrangement to create a palletized configuration for storage of empty carriers. In the depicted example, a fifth carrier (101e) stacked in line with a first, bottom carrier (101a) with three intervening carriers (101b-d) accommodated there-between. In such an arrangement, when carrier 101b is nested on top of carrier 101a (FIG. 13), the second feet (148b) of carrier 101b are accommodated in and through nesting element 133a of carrier 101a, causing the two carriers to be axially offset. Likewise, when carrier 101c is nested on top of carrier 101b, the second feet of carrier 101c are accommodated in and through nesting element 133 of carrier 101b causing the two carriers to be axially offset, and so on until carrier 101d is stacked on top of carrier 101c. Next, carrier 101e is stacked on top of carrier 101a with the second feet of carrier 101e engaged inside the groove 152 on the first feet of carrier 101a. At this point, the cumulative height of the offset carriers 101b-101d is around the clearance height 154 between the axially aligned carrier 101a, 101e. In this example, the cumulative dimensions of the stacked carriers 101a-e matches the dimensions of a standard pallet. It will be appreciated, however, that based on the dimensions of the pallet to be used, as well as the dimensions of individual carriers, additional such carriers may be similarly nested for compact storage.

It will be appreciated that the construction of first and second connector elements are not be limited to configurations of recess and feet, as depicted. While such an arrangement may be suitable in commercial operations for the transportation of young plants, carriers may be configured with alternate connectors that engage in a mated or other relationship to permit stacking of the carriers in the same manner, or an alternate suitable manner.

Carrier 101 having the features describe above may be constructed as a unitary one-piece construction. As non-limiting examples, the carriers may be manufactured via 3D printing, molding, and other knows methods of manufacture. The carriers 101 may be formed of any suitable material that will safely transport the young live plants during the normal rigors of transportation. Such material include, but are not limited to plastics, polypropylene, wood, and corrugated material. Optionally, a fully circular system may be provided by reusing plastic from existing carriers and trays that are not in use for the manufacture of the carriers of the present invention. This provides a sustainable design which is also cost effective since material costs tend to be a significant portion of manufacturing costs.

It will be appreciated that the disclosed features of the carrier of the present invention not only enable the carrier to be included in homogenous ensembles with one or more other similarly constructed carriers, but also to be included in heterogeneous ensembles with one or more other carriers having a compatible design and comprising compatible features.

It will be appreciated that while the carrier 101 is adapted to be used with trays of the present invention, this is not meant to be limiting. The carrier is adapted to be similarly used with trays that known in the art.

Turning now to plant propagation tray 102 (herein also referred to as “tray”), with reference to FIGS. 15-22, it also has a substantially rectangular geometry. Tray 102 is sized to be accommodated within carrier 101. Tray 102 comprises a quadrangular solid frame 202 which defines the edges and ends of the tray and which encloses multiple open ended cells 206 arranged in an array 204 of rows and columns. The array 204 has open cells uniformly spaced over N rows and M columns, making it an N×M array of cells. Each open ended cell 206 has a volume for receiving a plant pot therein, such as a plant paper pot with a young plant or plant propagule embedded therein. A size of each open ended cell may be adapted to accommodate a plant pot of one of various standard sizes. Accordingly, the number of open ended cells in the array may vary. In one example, the array is configured to accommodate 104 pots in a 13×8 array. In another example, the array is configured to accommodate 128 pots in a 16×8 array. Still other standard (or non-standard) tray arrays may be possible such as to accommodate 256 plant pots, 312 plant pots, etc. It will be appreciated that any tray configuration is possible within the scope of this invention.

As best illustrated at FIGS. 19-20, the array of cells 206 extend all the way to the edges of the frame 202. This enables a continuous growing field to be provided in a side-to-side direction by aligning trays, if desired. In addition, it maximizes the number of plants that can be accommodated on a given tray.

The frame 202 has a pair of opposing end walls 208 and a pair of opposing side walls 210. Each of the opposing side walls 208 of the frame are rectilinear and parallel to each other. Each of the opposing end walls of the frame are beveled with an angle directed away from the enveloped array. Specifically, the end walls slant outwards from a top edge that is closer to the array, towards a bottom edge of the end wall that is further away from the array. A distance between a given beveled end wall of the tray and the array of cells continuously increases from a top surface of the end wall to a bottom surface of the end wall. A cavity is provided between the beveled end wall of the tray and a terminal row of cells in the array. The cavity is sized to accommodate a lifting means therein, such as fingers for manual lifting or a robotic arm or other automated lifting mechanism.

Indicia 212 may be provided on the outer surface of the frame, on one or both of the side walls and the end walls. The indicia may be printed, pasted, embossed, etc., and may include indicia of any selected type, such as decorative indicia, trademarks, identification indicia, product information, operating instructions, and the like. In one example, the indicia includes a numerical identifier (e.g., “104”) that informs a user of the configuration of the tray and the number of plants that can be accommodated on the tray. Other forms of indicia may include barcodes (e.g., for stock keeping), color codes, as well as RFID tags.

One or more additional identification features 214, 216 may be provided at least on the end wall 208 of the tray frame 202. As one example, an outer surface of the end wall may comprise a tabbed slot 214 for receiving an identification element, such as an identification card or label, therein. The tabbed slot 214 has a shorter front panel, a longer back panel, and inwardly extending side panels that create a narrow space for receiving the identification element. The smaller height of the front panel enables a user to easily see the identification element. A tab element 216 extends upwards from the front panel and holds the identification element in place.

As another example, the outer surface of the end wall may comprise a smooth identification panel 218 onto which an identification element (e.g., label) can be pasted (and later removed), or onto which an identification element can be written/printed and subsequently erased for reuse.

The end walls comprise a deep groove 220 that extends from a bottom surface of the end wall and extends at least half the height of the end wall, towards the upper surface. The groove is positioned centrally resulting in the end wall 208 having a central region that is narrower than the terminal regions of the end wall. The groove also creates nesting elements 224 at the junction of the grove and the lower surface of the end wall. As elaborated below, the nesting elements 224 are used to stack trays compactly. This creates a handle-like structure in the central region of the end wall and allows a user to easily place or remove the tray on a carrier. Identification elements can be positioned on the end walls on either side of the groove 220. In one example embodiment, as depicted at FIGS. 15-17, a first identification element, such as a slot 214, is placed on one side of the groove while a second, different identification element, such as a panel 218, is placed on an opposite side of the groove 220.

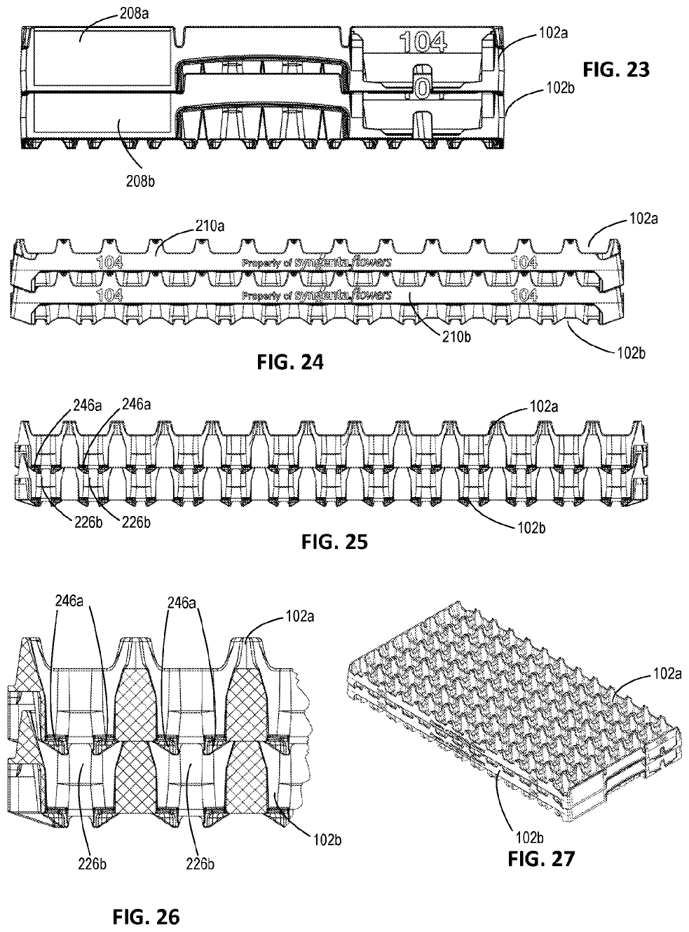

The narrower central region of the end wall has a notched upper surface. In particular, one or more notches 222 are provided on the upper surface of the end wall, in the narrowed region, aligned with the groove. As elaborated with reference to FIG. 23, the notch acts as a nesting slot that enables one or more trays to be stacked one on top of another to create a tray ensemble that can be easily stored and stowed. Specifically, when a second tray is stacked over a similarly configured first tray, nesting elements on a bottom surface of the end wall of the second (upper) tray matingly engage with the notch on an upper surface of the end wall of the first (lower) tray.

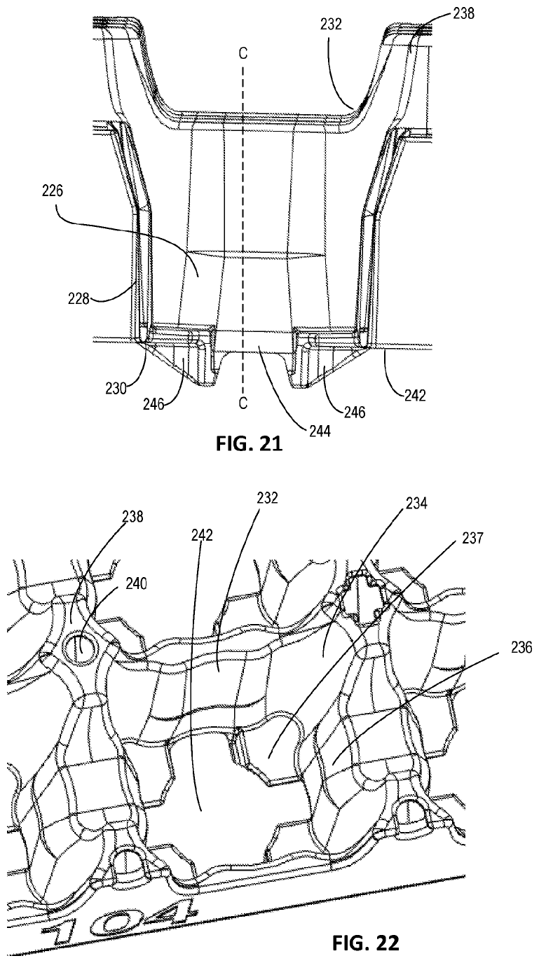

As best illustrated at FIGS. 21-22, each open cell 206 of the array is open at both a top and a bottom end and has a contoured wall 224 that envelops a central cavity 226 or volume. A plant pot, such as a paper pot, is received in this cavity. As described below, an inner surface of the wall is configured with various contour elements to facilitate receiving of a plant into the cavity as well as removal of the plant pot from the cavity.

Each cell 206 has a substantially rectangular shape. Wall 228 extends from a lower rim 230 that is coupled to structural elements on a bottom surface of the tray and an upper rim 232 that couples each cell to multiple adjacent cells. Each wall 228 extends straight upwards for at least a portion of the distance between the lower rim and the upper rim. In one example, wall 228 extends straight upwards from the lower rim to the upper rim for about half the height of the cell, and thereafter flares gradually outwards to the upper rim, away from a central axis C-C of the cell. By incorporating a straight portion in each wall of the cell, the bottom half of each cell has a volume that is adapted to act as a plug which fixedly holds a plant pot accommodated therein and limits movement of the accommodated plant pot in the cell. As a result, plant damage due to movement in the tray is averted. At the same time, by incorporating a flared, outwardly extending portion in each wall of the cell, the upper half of each cell has sufficient volume for leaves and stems extending out from a top of the plant pot. As such, each cell 206 is coupled to an adjacent cell only at the upper rim 232 and adjacent cells are separated from each other at the lower rim 230, as best shown at FIGS. 21-22.

The inner surface of the wall 228 is contoured to include recessed finger pockets 234 at each corner of the cell. The finger pockets 234 are recessed further away from the central axis C-C of the cell relative to straight alignment surfaces 236 provided between adjacent finger pockets. The alignment surfaces 236 assist in centering a plant pot positioned in the cell. The provision of recessed finger-pockets 234 at all corners of the cell, interspersed by alignment surfaces, creates a “hill and valley” configuration that facilitates manual and/or automated insertion and lifting of plant pots into and out of each cell.

A projection 237 extends along the bottom rim of the cell, from each finger pocket, inwards, towards the center of the cell (but not till the center of the cell). No such projections extend along the bottom rim from the alignment surface. This results in each cell having a partial floor at each corner location for supporting a plant pot positioned in the cell, and a central aperture 244. Air can easily flow in and out of the cell and the bottom of a plant pot placed in the cell via the aperture, reducing the likelihood of root circling or girdling in the plant pot.

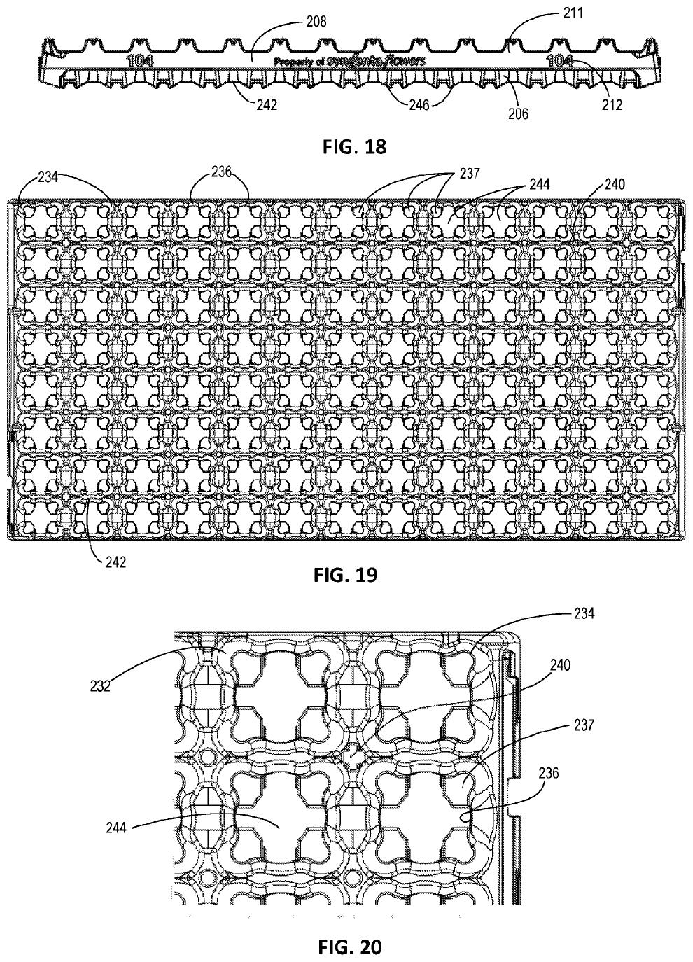

The wall surface extending from the finger pockets 234 to the upper rim 232 extends to a greater height than the remainder of the cell. The upper rim of each cell flares outwards from the central axis of the cell, and engages with the upper rim of an adjacent cell at a raised post 238 In this way, a plurality of raised posts 238 are provided that extend to a different planar height as compared to the remaining upper surface of the array of cells. In some embodiments, as best illustrated at FIGS. 16 and 18, the side wall 210 of the tray frame 202 is designed to have a uniformly spaced extension 211 that matches the profile of the raised posts 238. As shown at FIGS. 33-34, when tray 102 is positioned on carrier 101, the raised posts 238 extend above the planar height of the side walls 118 of the carrier, allowing for rapid identification of plants on the tray. For example, a user may be able to view the tray from the side of the plant transportation system and identify which plants are being transported without needing to remove or otherwise disturb the contents of the tray. In one example, the array of cells have a minimum height (from the bottom rim to the upper rim at its lowest region) of 24.4 mm and a maximum height (from the bottom rim to the top of a raised post) of 35.4 mm.

Each raised post 238 has a central opening 240 for accommodating an additional identification element, such as an identification flag for rapid identification of plants on the tray. This may be particularly advantageous when the young plants that are stored on the tray are flowering plants.

In addition to its use for transporting plant pots, the design of the tray allows for the modular use of multiple trays during a “growing phase” wherein multiple trays can be separated from their carriers and arranged next to each other in various configurations to allow for efficient plant growth. Trays may be arranged in a side to side configuration, or a lengthwise configuration, upon removal from their respective frames, resulting in a growing space that has a higher efficiency factor (e.g., 1.5 times higher efficiency).

Tray 102 having the features described above may be constructed as a unitary one-piece construction. As non-limiting examples, the trays may be manufactured via 3D printing, molding, and other knows methods of manufacture. The trays 102 may be formed of any suitable material that will safely transport the young live plants during the normal rigors of transportation. Such material include, but are not limited to plastics, polypropylene, wood, corrugated material, as well as other recyclable or disposable materials. In some embodiments, the trays 102 and the carriers 101 of the system are made of a common material.

Tray 102 further comprises a plurality of structural elements, configured in the depicted example as a plurality of uniformly spaced structural ribs 242, which run along a length and a width of the tray frame. The structural ribs engage with the lower rim 230 and projections 237 of cells 206 of the array 204. As best illustrated at FIGS. 19 and 21, the structural ribs 242 are positioned along the lower rim 230 in alignment with raised posts 238, thereby forming a lattice support structure around the central aperture 244 at a bottom of each cell 206. The lattice structure provides rigidity and stiffness to tray 102.

As shown at least at FIG. 21, one or more beveled spacer elements 246 extends downward from corner projection 237 of each cell, thereby creating feet-like structures below each cell. In one example embodiment, a set of at least four such spacer elements are provided for each cell, coupled to four corresponding corners of the cell. When tray 102 is placed on carrier 101, spacer elements 246 engage with the base of the carrier. In particular, the spacer elements slidingly interact with the sliding rail of the carrier, allowing the tray to be easily inserted or removed from the carrier. For any given cell 206, each beveled spacer element of the set of spacer extends at an angle from the lower rim 230 of the cell (immediately below projection 237) towards central aperture 244, without extending over the central aperture. This allows the central aperture to remain unimpeded. The spacer elements are adapted to create a gap or space between the carrier base and each cell of the array when tray 102 is placed on carrier 101. This improves air flow to the cell when the tray is engaged with the carrier.

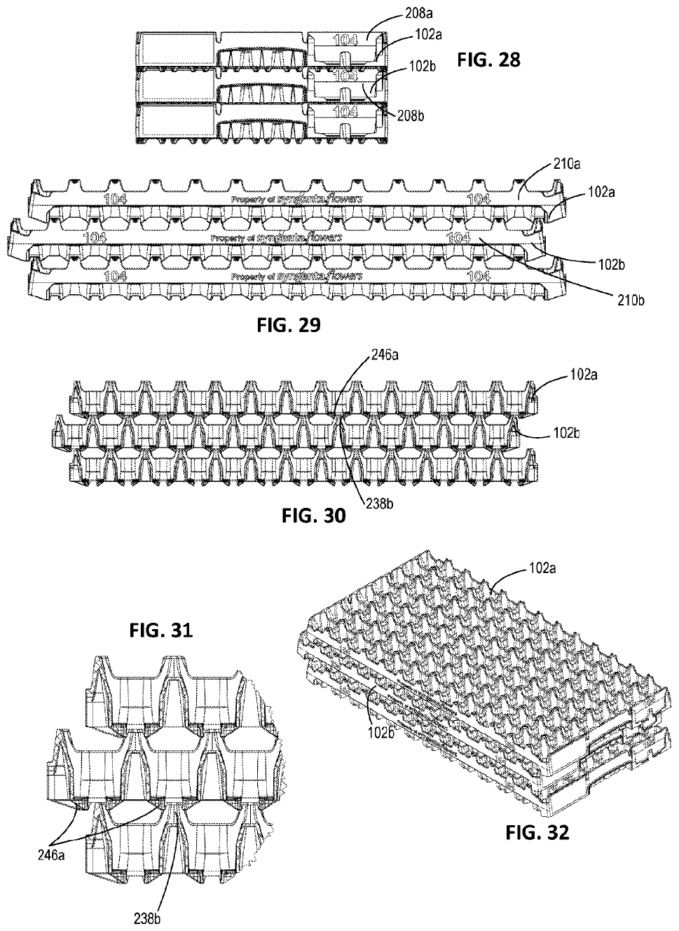

The spacer elements 246 also enable a tray to be stacked with one or more similarly designed trays to create an ensemble of trays as shown in FIGS. 24-32. When plant transportation is not required, multiple trays can be stacked or nested compactly, allowing them to be easily stored, stowed and/or transported. Based on a desired stacking configuration, the spacer elements of a given tray engage with either the central cavity 226 of another tray, or with the raised posts of another tray, as elaborated below. The trays may be stacked with additional trays in an aligned configuration, as described at FIGS. 23-27, or they may be stacked in an offset configuration, as described at FIGS. 28-32. The offset configuration results in a larger space being created above each cell and between trays (relative to the aligned configuration) which enables an ensemble of trays with plant pots accommodated in respective tray cells to be stacked and stored. Further, the ensemble of stacked trays may be combined with one or more carriers to create a palletized structure that has the dimensions matching a standard pallet. For example, an ensemble of aligned or offset trays may be stacked between an ensemble of aligned carriers to create a pallet that is easily stored when the trays and carriers are not used for plant transportation. In the depicted cross-section figures, empty spaces between individual cells of an array, as well as between stacked trays, are depicted via cross hatching.

In one example configuration, as depicted at FIGS. 24-27, multiple trays may be stacked in an aligned configuration to create a pallet of empty trays. Therein, when a first tray 102a is stacked on top of a second tray 102b, spacer elements 246a of cells 206a of the first tray 102a are accommodated within the central cavity 226b of a corresponding underlying cell 206b of the second tray 102b. This results in cells of a given tray being aligned with corresponding cells of another tray stacked above or below it. In this configuration, end walls 208a, 208b of the first and second trays 102a, 102b, respectively, and all associated features (such as slots, tabs, indicia, grooves, notches, etc.), are aligned, and in the same plane. Likewise, side walls 210a, 210b of the first and second trays 102a, 102b, and all associated features (such as indicia, projections, etc.), respectively, are aligned.

In another example configuration, as depicted at FIGS. 28-32, multiple trays may be stacked in an offset configuration to create a pallet of empty trays. Therein, when a first tray 102a is stacked on top of a second tray 102b, spacer elements 246a of cells 206a of the first tray 102a are accommodated on, and engage with, the raised post 238b of a corresponding underlying cell 206b of the second tray 102b. This results in cells of a given tray being offset from corresponding cells of another tray stacked above or below it. In this configuration, end walls 208a, 208b of the first and second trays 102a, 102b, respectively, and all associated features (such as slots, tabs, indicia, grooves, notches, etc.), are axially offset. Likewise, side walls 210a, 210b of the first and second trays 102a, 102b, and all associated features (such as indicia, projections, etc.), respectively, are axially offset.

It will be appreciated that the construction of the spacer elements are not meant to be limited to configurations of beveled feet, as depicted. While such an arrangement may be suitable in commercial operations for the transportation of young plants, trays may be configured with alternate connectors that engage in a mated relationship to permit stacking of the trays in the same manner, or an alternate suitable manner. The carriers and trays having the feature described above allow for a facile method of transporting one or more items, such as living plant materials. They also enable methods of creating tray ensemble, carrier ensembles, or carrier-tray ensembles. The carrier and trays can be stacked in different combinations resulting in a modular plant transportation system that facilitates plant propagation while also providing compact storage capabilities.

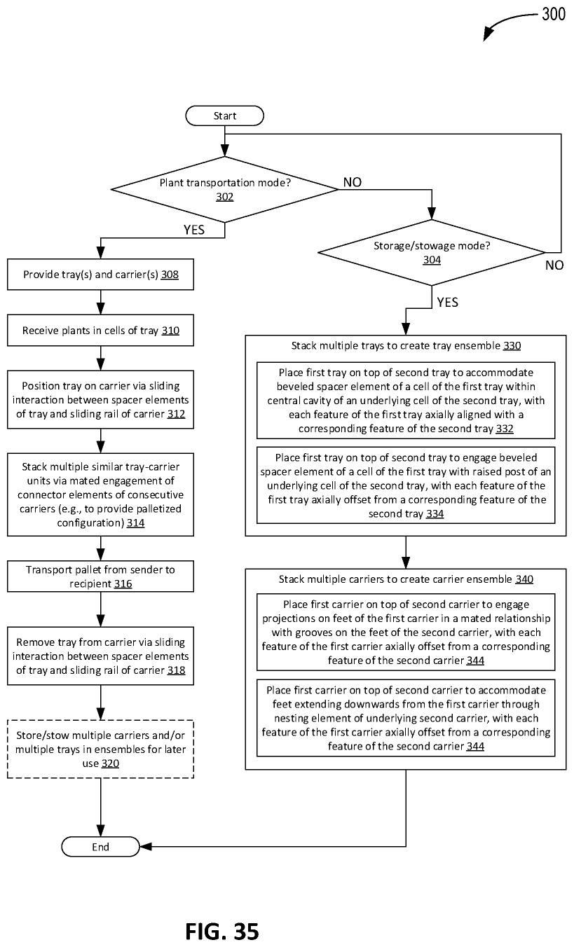

FIG. 35 depicts a high level flow chart of an example method 300 for operating the modular plant transportation system of FIG. 1. Different configurations are created based on whether the transportation system is to be operated in a transportation mode (step 302) for transporting young plants from an intended sender to an intended recipient, or whether the system is to be operated in a storage or stowage mode (step 304) for compactly storing trays and carriers not being used for transporting plants.

In one intended embodiment, when a transportation mode is selected, a method of transporting young plants from an intended sender to an intended recipient comprises providing (step 308) a tray with an array of open ended cells enclosed within a frame, wherein a section of an upper rim of each cell is raised to engage with a similarly raised upper rim of an adjacent cell at a raised post, and wherein each cell includes a set of beveled spacer elements coupled to a lower rim of the cell. The method further comprises providing (step 308) a rectangular carrier with a perforated base and a pair of opposing side walls extending from the base that are higher than a pair of opposing end walls, the carrier comprising one of more sliding rails arranged on an upper surface of the base, and a pair of cross bracing diagonal ribs arranged on a lower surface of the base. The carrier further comprises a first set of feet having a terminal groove, the first set of feet extending upwards from the tray; a second set of feet having a terminal projection, the second set of feet extending downwards from the tray, and nesting spaces at corners of the base. Next, the method comprises receiving (step 310) a plurality of plants in the plurality of open ended cells of the tray, and placing (step 312) the tray on the carrier via sliding interaction between the beveled spacer elements of the tray and a sliding rail (e.g., central sliding rail) of the carrier (FIG. 33). One or more trays may be similarly placed on corresponding one or more carriers to create tray-carrier units. Then, multiple such units are stacked together (step 314) to provide a palletized transportation system wherein individual units are coupled to each other via mated interaction between the groove of a carrier and the projection of another carrier stacked thereon. Upon reaching the intended recipient, the one or more trays can be removed (step 316) via a similar sliding interaction between the beveled spacer elements of the tray and the sliding rail of the carrier. Optionally, the carriers and trays can then be stacked to create ensembles for transportation, storage, and/or later use (step 320).

When transportation of plants is not required, such as in a storage mode (step 304), the above-described features of the trays and carriers allows for compact stacking of multiple trays to create an ensemble of trays, and compact stacking of multiple carriers to create an ensemble of carriers. One example method for creating an ensemble of trays (step 330) comprises placing a first tray on top of a second tray such that the beveled spacer element of a cell of the first tray is accommodated, in a mating relationship, within a central cavity of an underlying cell of the second tray, with each feature of the first tray axially aligned with a corresponding feature of the second tray (step 332). An alternate example method for creating an ensemble of trays comprises placing a first tray on top of a second tray such that the beveled spacer element of a cell of the first tray is matingly engaged with a raised post of an underlying cell of the second tray, with each feature of the first tray axially offset from a corresponding feature of the second tray (step 334).

One example method for creating an ensemble of carriers (step 340) comprises placing a first carrier on top of a second carrier such that the feet extending downwards from the first carrier are accommodated through the nesting space of the underlying second carrier, with each feature of the first carrier axially offset from a corresponding feature of the second carrier (step 344). An alternate example method for creating an ensemble of carriers comprises placing a first carrier on top of a second carrier such that the projections on the feet of the first carrier are in a mated relationship with grooves on the feet of the second carrier, with each feature of the first carrier axially offset from a corresponding feature of the second carrier (step 342).

In this way, the various features of the tray and the carrier enables a tray to be slid onto a carrier while the tray is held stable during transportation. Handle portions at the front and back of each tray enable the tray to be easily picked up from either end. Rounded edges and bottom features of the tray allow for ease of tray handling. Open (and shorter) ends of the carrier enable the carrying surface of the carrier to be accessed on two sides, even when multiple carriers are stacked into an ensemble. The stepped bottom surface of the carrier, resulting from the inclusion of sliding rails, allows for easy sliding of trays onto the carrier.

The description herein is merely exemplary in nature and, thus, variations that do not depart from the gist of that which is described are intended to be within the scope of the teachings. Such variations are not to be regarded as a departure from the spirit and scope of the teachings. The scope of the invention should be determined by the appended claims and their legal equivalents.

1. A carrier system, comprising:
a) a carrier comprising a perforated base, a pair of opposing side walls extending upwards from the base to a first height, a pair of opposing end walls extending upwards from the base to a second height, lower than the first height, a plurality of spaced apart first connector elements extending upward from each side wall, a plurality of spaced apart second connector elements extending downwards from each side wall, wherein each of the plurality of first connector element is sized and adapted to engage with the second connector element of a similarly constructed carrier; and
b) a tray that is adapted to be accommodated on the upper surface of the base of the carrier, the tray having a rectangular frame enclosing a plurality of open-ended cells arranged in an array, each cell enclosing a central cavity for receiving a plant pot, a bottom surface of each cell comprising one or more spacer elements, wherein the tray is insertable onto and/or removable from the base of the carrier while the carrier is engaged with another similarly constructed carrier.

2. The system of claim 1, wherein an upper surface of the base comprises one or more raised sliding rails and wherein the tray is insertable onto and/or removable from the base of the carrier via sliding interaction between at least some of the spacer elements over at least some of the sliding rails

3. The system of claim 2, wherein a lower surface of the base further comprises diagonal ribs, raised outwardly away from the bottom surface, the diagonal ribs configured to provide torsional stiffness to the carrier.

4. The system of claim 3, wherein the diagonal ribs are arranged at an angle to each other to form a cross brace on the lower surface of the base.

5. The system of claim 1, wherein the tray is insertable and/or removable onto/from the base via the sliding interaction while the first connector element of the carrier is engaged to the second connector element of a similarly shaped carrier stacked on top of the given carrier.

6. The system of claim 1, wherein the first height of the side walls of the carrier is greater than the second height of the end walls of the carrier.

7. The system of claim 1, wherein the tray is accommodated onto the carrier over an end wall of the carrier, and wherein upon accommodating the tray on the carrier, lateral movement of the tray is limited via the side walls of the carrier and longitudinal movement of the tray is limited via the terminal walls of the carrier.

8. The system of claim 1, wherein the one or more sliding rails includes a central sliding rail raised from the base of the frame and extending along a central longitudinal axis of the carrier.

9. The system of claim 8, wherein the one or more sliding rails includes one or more peripheral sliding rails, parallel to and offset from the central sliding rail.

10. The system of claim 1 The system of any of the preceding claims, wherein the carrier further comprises a nesting element comprising an opening at a corner of the base, and wherein when another similarly constructed carrier is nested on top of the given carrier, the second connector element of the another carrier is received through the opening of the given carrier.

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

11. A plant propagation tray, comprising:
a plurality of open ended cells arranged in an array, the array enclosed within a rectangular frame, each cell defining a cavity for receiving a plant pot;
a plurality of spaced structural ribs running along a length and a width of a bottom surface of the array, thereby creating a lattice support structure below the array; and
a set of beveled spacer elements extending, at an angle, from a bottom rim of each cell towards a central axis of the cell.

12. The tray of claim 11, wherein the lattice structure includes a central aperture coaxial with the cavity of each cell, and wherein the beveled spacer elements do not extend over the central aperture.

13. The tray of claim 11, wherein a wall of each extends straight upwards from a bottom rim of the cell for a first distance, and then flares outwards, away from the central axis, to an upper rim of each cell, and wherein the upper rim of each cell flares away from the central axis of the cell, and engages with the upper rim of an adjacent cell at a raised post.

14. The tray of claim 13, wherein the raised post has a central opening for accommodating an identification element including an identification flag.

15. The tray of claim 11, wherein each cell is substantially quadrangular in shape, and wherein an inner surface of each cell is recessed at each corner and protrudes inwards in a region between adjacent corners.

35. (canceled)

36. (canceled)

37. (canceled)

38. (canceled)

39. (canceled)

40. (canceled)

41. (canceled)

42. (canceled)

43. (canceled)

44. (canceled)

16. A carrier system, comprising:
a) a carrier comprising a perforated base, a pair of opposing side walls extending upwards from the base to a first height, a pair of opposing end walls extending upwards from the base to a second, different height, a plurality of spaced apart first connector elements extending upward from each side wall, a plurality of spaced apart second connector elements extending downwards from each side wall, wherein each of the plurality of first connector element is sized and adapted to engage with the second connector element of a similarly constructed carrier, an upper surface of the base comprising one or more raised sliding rails; and
b) a tray that is accommodated on the upper surface of the base of the carrier, the tray having a rectangular frame enclosing a plurality of open-ended cells arranged in an array, each cell enclosing a central cavity for receiving a plant pot, a bottom surface of each cell comprising one or more spacer elements, wherein the tray is insertable onto and/or removable from the base of the carrier via sliding interaction between at least some of the spacer elements over at least some of the sliding rails.

17. A carrier, comprising:
a base having an upper surface and a lower surface and optionally a plurality of perforations extending through the base;
a pair of opposing side walls extending upwards from a first plane of the base to a first height;
a pair of opposing end walls extending upwards from a second, different plane of the base to a second, different height, wherein the pair of opposing side walls are coupled to corresponding end walls via an angled structure that transitions from the first plane to the second plane;
a plurality of spaced apart first feet extending upwards from each side wall;
a plurality of spaced apart second feet extending downwards from each side wall, the first feet aligned with corresponding second feet, the first feet comprising a groove for accommodating the first feet of another carrier layered on top of the given carrier;
one or more sliding rails raised away from the upper surface of the base; and
an opening at each corner of the base.

18. The carrier of claim 17, further comprising: at least a pair of diagonal ribs raised outwardly away from the lower surface of the base, the pair of diagonal ribs arranged at an angle relative to each other to form a cross-bracing structure that provides torsional stiffness to the carrier.

19. A carrier, comprising:
a base having an upper surface and a lower surface and optionally a plurality of perforations extending through the base;
a pair of opposing side walls extending upwards to a first height;
a pair of opposing end walls extending upwards to a second, different height, wherein the pair of opposing side walls are coupled to corresponding end walls via an angled structure;
a plurality of spaced apart first feet extending upwards from each side wall;
a plurality of spaced apart second feet extending downwards from each side wall, the first feet aligned with corresponding second feet, the first feet comprising a groove for accommodating the first feet of another carrier layered on top of the given carrier;
at least a pair of diagonal ribs raised outwardly away from the lower surface of the base, the pair of diagonal ribs arranged at an angle relative to each other to form a cross-bracing structure that provides torsional stiffness to the carrier; and
an opening at each corner of the base.

20. The carrier of claim 19, further comprising one or more sliding rails raised away from the upper surface of the base.

50. (canceled)
